(19) United States
(12) Patent Application Publication
(10) Pub. No.: US 2013/0209915 A1
(43) Pub. Date: Aug. 15, 2013

(54) ELECTROLYTE SOLUTION FOR LITHIUM BATTERY, LITHIUM BATTERY INCLUDING ELECTROLYTE SOLUTION, ELECTROLYTE SOLUTION FOR LITHIUM AIR BATTERY, AND LITHIUM AIR BATTERY INCLUDING ELECTROLYTE SOLUTION

(71) Applicants: Tsunehisa Hirashita, Nagoya-shi (JP); Hirofumi Nakamoto, Susono-shi (JP); Taishi Shiotsuki, Susono-shi (JP)

(72) Inventors: Tsunehisa Hirashita, Nagoya-shi (JP); Hirofumi Nakamoto, Susono-shi (JP); Taishi Shiotsuki, Susono-shi (JP)

(73) Assignees: NATIONAL UNIVERSITY CORPORATION NAGOYA INSTITUTE OF TECHNOLOGY, Nagoya-shi, Aichi (JP); TOYOTA JIDOSHA KABUSHIKI KAISHA, Toyota-shi, Aichi-ken (JP)

(21) Appl. No.: 13/817,338

(22) PCT Filed: Oct. 24, 2011
(86) PCT No.: PCT/IB2011/002536

§ 371 Date: Feb. 15, 2013

(30) Foreign Application Priority Data
Oct. 25, 2010 (JP) 2010-238513

(51) Int. Cl. H01M 8/08

(52) U.S. Cl. CPC H01M 8/08
USPC 429/498; 429/188

(57) ABSTRACT

An electrolyte solution for a lithium battery contains 1-butyl-3-methyltetrazolium-5-olate represented by formula (1).

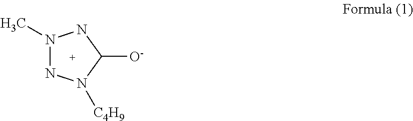

### BACKGROUND OF THE INVENTION

1. Field of the Invention

The invention relates to an electrolyte solution for a lithium battery, a lithium battery including the electrolyte solution, an electrolyte solution for a lithium air battery, and a lithium air battery including the electrolyte solution, in which excellent lithium ion conductivity is exhibited.

2. Description of Related Art

Secondary batteries can be discharged in a process where chemical energy generated by a chemical reaction is converted to electric energy. In addition, secondary batteries can also store electric energy converted to chemical energy (i.e., secondary batteries can be charged), by causing current to flow in the direction opposite to the direction during discharge. Among secondary batteries, lithium secondary batteries are widely used, on account of their high energy density, as power sources in notebook-type personal computers, cell phones and the like.

In a case where graphite (notated as C) is used as a negative electrode active material in the lithium secondary battery, the reaction represented by formula (I) below takes place at the negative electrode during discharge.

LiₓC→C+xLi⁺+xe⁻ (I)

(in formula (I), 0<x<1)
The electrons generated in formula (I) pass through an external circuit, perform work in an external load, and reach the positive electrode. The lithium ions (Li⁺) generated in formula (I) migrate by electro-osmosis from the negative electrode to the positive electrode, by way of an electrolyte that is sandwiched between the negative electrode and the positive electrode.

In a case where lithium cobalt oxide (Li₁₋ₓCoO₂) is used as a positive electrode active material, the reaction of formula (II) below takes place at the positive electrode during discharge.

Li₁₋ₓCoO₂+xLi⁺+xe⁻→LiCoO₂ (II)

(in formula (II), 0<x<1)
During charging, reverse reactions of the respective reactions in formula (I) and formula (II) take place in the negative electrode and the positive electrode, so that Li-intercalated graphite (LiₓC), resulting from intercalation of lithium into graphite, is regenerated in the negative electrode, while lithium cobaltate (Li₁₋ₓCoO₂) is regenerated in the positive electrode. Re-discharge becomes possible as a result.

Flammable and volatile organic solvents are used in the electrolyte solutions of conventional lithium secondary batteries, and hence there is a limitation on the improvement of safety. Various conventional lithium secondary batteries are available in which ionic liquids are used in the electrolyte solution, as a way of achieving higher safety. The term ionic liquid denotes a salt that is liquid at a temperature equal to or lower than 100° C., and that is ordinarily flame-retardant and non-volatile. Such flame-retardant electrolyte solutions are advantageous not only in that they afford higher safety, but also in that they have a comparatively wide potential window (potential region) and exhibit comparatively high ion conductivity.

As an example of a technology relating to a lithium ion secondary battery including an ionic liquid, Japanese Patent Application Publication No. 2008-305574 (JP-A-2008-305574) describes a lithium ion secondary battery that includes a non-aqueous electrolyte solution resulting from dissolving a lithium salt and KPF₂(C₂O₄)₂ in a mixed solvent of an organic solvent and a room-temperature molten salt (ionic liquid).

Claim 1 of JP-A-2008-305574 sets forth a feature wherein a non-aqueous electrolyte solution includes an organic solvent. Examples in JP-A-2008-305574 describes a battery in which a mixed solvent of ethylene carbonate (EC) and diethyl carbonate (DEC) is used in a non-aqueous electrolyte solution. Ordinarily, organic solvents volatilize readily, and hence the performance of a battery that uses a non-aqueous electrolyte solution in the form of a mixed solution of an ionic liquid and an organic solvent depends, after prolonged operation, mainly on the performance of the ionic liquid. Conventional electrolyte solutions containing an ionic liquid have poorer lithium ion conductivity than electrolyte solutions containing an organic solvent alone, and are accordingly impractical.

### SUMMARY OF THE INVENTION

The invention provides an electrolyte solution for a lithium battery, a lithium battery including the electrolyte solution, an electrolyte solution for a lithium air battery, and a lithium air battery including the electrolyte solution, in which excellent lithium ion conductivity is exhibited.

A first aspect of the invention relates to an electrolyte solution for a lithium battery. The electrolyte solution for a lithium battery contains 1-butyl-3-methyltetrazolium-5-olate represented by formula (1).

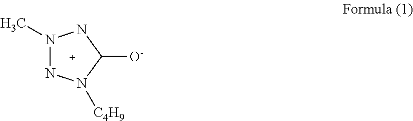

A second aspect of the invention relates to a lithium battery. The lithium battery includes a positive electrode, a negative electrode and an electrolyte solution provided between the positive electrode and the negative electrode, wherein the electrolyte solution is the electrolyte solution for a lithium battery according to the first aspect.

A third aspect of the invention relates to an electrolyte solution for a lithium air battery. The electrolyte solution for a lithium air battery contains 1-butyl-3-methyltetrazolium-5-olate represented by formula (1) below.

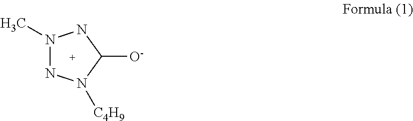

A fourth aspect of the invention relates to a lithium air battery. The lithium air battery includes an air electrode, a negative electrode, and an electrolyte solution provided between the air electrode and the negative electrode, wherein the electrolyte solution is the electrolyte solution for a lithium air battery according to the third aspect.

In the aspects of the invention, the electrolyte solution for a lithium battery and the electrolyte solution for a lithium air battery contain 1-butyl-3-methyltetrazolium-5-olate represented by formula (1). As a result, the electrolyte solution for a lithium battery and electrolyte solution for a lithium air battery according to the aspects of the invention afford the low-volatility inherent to ionic liquids, and, in addition, excellent lithium ion conductivity.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram illustrating an example of the layer configuration of a lithium battery according to an embodiment of the invention, wherein the diagram illustrates schematically a section taken along a stacking direction; and

FIG. 2 is a graph illustrating comparatively the lithium ion transport numbers of the electrolyte solutions of Examples 1 and 2 and Comparative examples 1 and 2.

### DETAILED DESCRIPTION OF EMBODIMENTS

1. Electrolyte Solution for a Lithium Battery

The electrolyte solution for a lithium battery according to an embodiment of the invention (hereafter also referred to as electrolyte solution according to the embodiment of the invention) contains 1-butyl-3-methyltetrazolium-5-olate represented by formula (1).

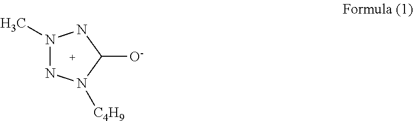

An explanation follows next on a method for manufacturing 1-butyl-3-methyltetrazolium-5-olate that is used in the embodiment of the invention. The method for manufacturing 1-butyl-3-methyltetrazolium-5-olate that is used in the embodiment of the invention is not necessarily limited to the example explained herein alone. The production example includes steps (1) to (3) as follows: (1) step of producing a tetrazole-5-thione derivative having a butyl group at the 1 position; (2) step of producing a thiotetrazole derivative having a thioester group at the 5 position; and (3) step of producing a tetrazolium-5-olate having a butyl group at the 1 position and a methyl group at the 3 position.

Steps (1) to (3) are explained in detail below. In step (1), firstly, an alkali azide (MN₃, wherein M denotes an alkali metal) and butyl isothiocyanate (C₄H₉NCS) are caused to react as indicated by reaction formula (a) below, to synthesize a tetrazole-5-thione derivative having a butyl group at the 1 position.

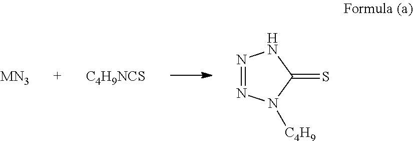

Next, in step (2), the tetrazole-5-thione derivative synthesized in step (1) and an alkyl halide (RX) are caused to react, in the presence of a base, to synthesize a thiotetrazole derivative having a thioester group at the 5 position, as indicated by reaction formula (b) below. As the alkyl halide, for instance, an alkyl bromide or the like may be used. Preferably, the alkyl halide has four or fewer carbon atoms, since hydrolysis in the below-described step (3) may be difficult if the alkyl halide used has five or more carbon atoms, for instance octyl bromide or the like. The base that is used is not particularly limited, and may be, for instance, sodium alcoholate.

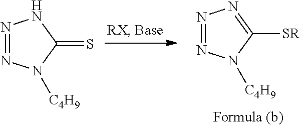

Next, in step (3), the thiotetrazole derivative synthesized in step (2) above is methylated by a methylating agent, and is hydrolyzed by a base, to synthesize 1-butyl-3-methyltetrazolium-5-olate, as indicated by reaction formula (c) below. The methylating agent is not particularly limited, so long as it is capable of introducing a methyl group at the 3 position of the tetrazole ring. Examples of the methylating agent that can be used include, for instance, dimethyl sulfate, methyl triflate or the like. The base is not particularly limited, so long as it is capable of inactivating excess methylating agent and of hydrolizing the methylated thiotetrazole derivative.

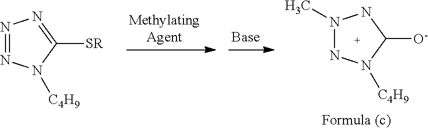

Preferably, the electrolyte solution according to the embodiment of the invention further contains a lithium salt, as a supporting salt, in addition to the abovementioned 1-butyl-3-methyltetrazolium-5-olate. Examples of lithium salts include, for instance, inorganic lithium salts such as LiPF₆, LiBF₄, LiClO₄ and LiAsF₆; and organic lithium salts such as LiCF₃SO₃, LiN(SO₂CF₃)₂(Li-TFSI), LiN(SO₂C₂F₅)₂ and LiC(SO₂CF₃)₃. Such lithium salts may be used in combinations of two or more salts. The amount of lithium salt added to the tetrazolium mesoionic compound is not particularly limited, but ranges preferably from about 0.1 to 1.5 mol/kg.

The electrolyte solution according to the embodiment of the invention may include a non-aqueous electrolyte, in addition to the abovementioned 1-butyl-3-methyltetrazolium-5-olate and lithium salt. A non-aqueous electrolyte solution or a non-aqueous gel electrolyte can be used as the non-aqueous electrolyte. A non-aqueous electrolyte solution ordinarily contains the above-described lithium salt and a non-aqueous solvent. Examples of the non-aqueous solvent include, for instance, ethylene carbonate (EC), propylene carbonate (PC), dimethyl carbonate (DMC), diethyl carbonate (DEC), ethyl methyl carbonate (EMC), ethyl carbonate, butylene carbonate, γ-butyrolactone, sulfolane, acetonitrile, 1,2-dimethoxyethane, 1,3-dimethoxypropane, diethyl ether, tetrahydrofuran, 2-methyl tetrahydrofuran, as well as mixtures of the foregoing. Preferably, the non-aqueous solvent has high oxygen solubility so that dissolved oxygen can be effectively used in the reaction. The concentration of lithium salt in the non-aqueous electrolyte solution ranges for instance from 0.5 mol/L to 3 mol/L.

The non-aqueous gel electrolyte used in the embodiment of the invention is ordinarily a gelled product resulting from adding a polymer to a non-aqueous electrolyte solution. The non-aqueous gel electrolyte can be obtained, for instance, through gelling by adding a polymer such as polyethylene oxide (PEO), polyacrylonitrile (PAN), polymethylmethacrylate (PMMA) or the like to the above-described non-aqueous electrolyte solution. In the embodiment of the invention, for instance, a LiTFSI (LiN(CF₃SO₂)₂)-PEO-based non-aqueous gel electrolyte can be used.

2. Lithium Battery

The lithium battery according to the embodiment of the invention is a lithium battery that includes at least a positive electrode; a negative electrode, and an electrolyte solution provided between the positive electrode and the negative electrode, wherein the electrolyte solution is the electrolyte solution for a lithium battery.

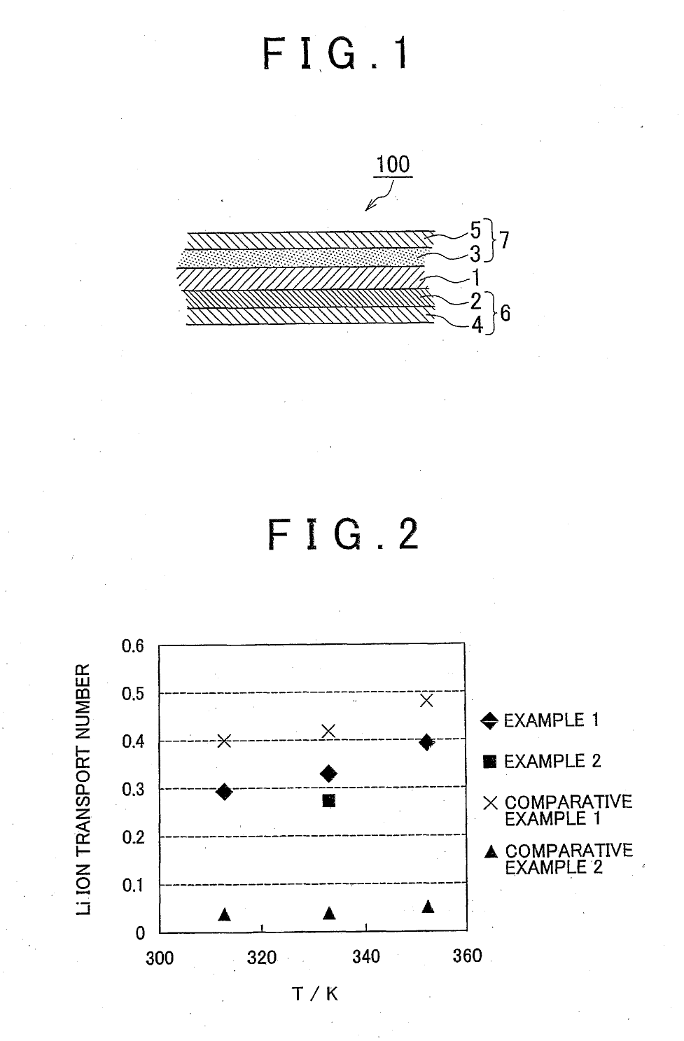

FIG. 1 is a diagram illustrating an example of the layer configuration of the lithium battery according to the embodiment of the invention, wherein the diagram illustrates schematically a section taken along a stacking direction. The lithium battery according to the embodiment of the invention is not necessarily limited to only this example. A lithium battery 100 includes: a positive electrode 6 that includes a positive electrode active material layer 2 and a positive electrode collector 4; a negative electrode 7 that includes a negative electrode active material layer 3 and a negative electrode collector 5; and an electrolyte solution 1 sandwiched between the positive electrode 6 and the negative electrode 7. The electrolyte solution in the lithium battery according to the embodiment of the invention is as, described above. A detailed explanation follows next on the constituent elements of the lithium battery according to the embodiment of the invention, namely the positive electrode, the negative electrode, a separator and a battery case.

(Positive Electrode)

Preferably, the positive electrode of the lithium battery according to the embodiment of the invention includes a positive electrode active material layer that has a positive electrode active material. In addition, the positive electrode ordinarily includes a positive electrode collector and a positive electrode lead connected to the positive electrode collector. If the lithium battery according to the embodiment of the invention is a lithium air battery, the battery includes an air electrode including an air electrode layer, instead of the positive electrode.

(Positive Electrode Active Material Layer)

An explanation follows next on an instance where a positive electrode including a positive electrode active material layer is used as the positive electrode. Specific examples of the positive electrode active material that is used in the embodiment of the invention include, for instance, LiCoO₂, LiNi_{1/3}Mn_{1/3}Co_{1/3}O₂, LiNiPO₄, LiMnPO₄, LiNiO₂, LiMn₂O₄, LiCoMnO₄, Li₂NiMn₃O₈, Li₃Fe₂(PO₄)₃ and Li₃V₂(PO₄)₃. From among the foregoing, LiCoO₂ is preferably used as the positive electrode active material in the embodiment of the invention.

The thickness of the positive electrode active material layer used in the embodiment of the invention varies depending on, for instance, the intended application of the lithium battery, and ranges preferably from 10 μm to 25 μm, particularly preferably from 20 μm to 200 μm, and most preferably from 30 μm to 150 μm.

The average particle size of the positive electrode active material ranges for instance from 1 μm to 50 μm, preferably from 1 μm to 20 μm, and in particular from 3 μm to 5 μm. Handleability may become impaired if the average particle size of the positive electrode active material is too small, whereas an excessively large average particle size of the positive electrode active material may make it difficult to obtain a flat positive electrode active material layer. The average particle size of the positive electrode active material can be determined by, for instance, measuring particle sizes of an active material carrier as observed by scanning electron microscopy (SEM), and averaging the measured particle sizes.

The positive electrode active material layer may contain a conductivity-imparting material, a binder and the like as required. The conductivity-imparting material in the positive electrode active material layer that is used in the embodiment of the invention is not particularly limited, so long as the conductivity-imparting material allows enhancing the conductivity of the positive electrode active material layer. Examples of the conductivity-imparting material include, for instance, carbon black such as acetylene black, Ketchen black or the like. The content of conductivity-imparting material in the positive electrode active material layer varies depending on the type of the conductivity-imparting material, and ranges ordinarily from 1% by mass to 10% by mass.

Examples of the binder in the positive electrode active material layer used in the embodiment of the invention include, for instance, polyvinylidene fluoride (PVDF), polytetrafluoroethylene (PTFE) and the like. The content of the binder in the positive electrode active material layer may be such an amount, and preferably less, as allows the positive electrode active material and the like to be immobilized. The binder content ranges ordinarily from 1% by mass to 10% by mass.

(Positive Electrode Collector)

The positive electrode collector used in the embodiment of the invention has the function of collecting power from the positive electrode active material layer. Examples of the material of the positive electrode collector include, for instance, aluminum, SUS, nickel, iron and titanium, preferably aluminum and SUS. The positive electrode collector may be in the form of, for instance, a foil, a plate, or a mesh, preferably a foil.

The configuration may be such that the electrode active material layer of at least one of the positive electrode and the negative electrode contains at least an electrode active material and an electrode electrolyte. In this case, the electrode electrolyte that is used may be, for instance, a solid electrolyte such as a solid oxide electrolyte or a solid sulfide electrolyte, or the above-described gel electrolyte.

The method for producing the positive electrode used in the embodiment of the invention is not particularly limited, so long as the method allows obtaining the above-described positive electrode. After formation of the positive electrode active material: layer, the positive electrode active material layer may be pressed in order to enhance electrode density.

(Air Electrode Layer)

An explanation follows next on an instance where an air electrode including an air electrode layer is used as the positive electrode. The air electrode layer used in the embodiment of the invention contains at least a conductive material. The air electrode layer may further contain, as required, at least one of a catalyst and a binder.

The conductive material that is employed in the air electrode layer used in the embodiment of the invention is not particularly limited, so long as the material has conductivity. For instance, a carbon material or the like can be used. The carbon material may have a porous structure or may not have a porous structure. In the embodiment of the invention, however, the carbon material has preferably a porous structure. This is because when the carbon material has a porous structure, a specific surface area is large, and many reaction sites can be provided. Specific examples of carbon materials having a porous structure include, for instance, mesoporous carbon. Specific examples of carbon materials that do not have a porous structure include, for instance, graphite, acetylene black, carbon nanotubes and carbon fibers. The content of conductive material in the air electrode layer ranges, for instance, from 65% by mass to 99% by mass, preferably from 75% by mass to 95% by mass. This is because when the content of conductive material is excessively small, the reaction sites may decrease, which may result in decrease in the battery capacity, and when the content of conductive material is excessively large, the catalyst content may relatively decrease, which may make it impossible to provide sufficient catalytic function.

Examples of the catalyst that is employed in the air electrode layer used in the embodiment of the invention include, for instance, cobalt phthalocyanine and manganese dioxide. The content of catalyst in the air electrode layer ranges, for instance, from 1% by mass to 30% by mass, preferably from 5% by mass to 20% by mass. This is because when the catalyst content is excessively small, it may be impossible to provide sufficient catalytic function, and when the catalyst content is excessively large, the content of conductive material may relatively decrease and the reaction sites may decrease, which may result in decrease in the battery capacity. From the viewpoint of achieving a smoother electrode reaction, preferably, the catalyst is supported by the above-described conductive material.

The air electrode layer need only contain at least a conductive material, but preferably further contains a binder for immobilizing the conductive material. Examples of the binder include, for instance, polyvinylidene fluoride (PVDF), polytetrafluoroethylene (PTFE) and the like. The content of binder in the air electrode layer is not particularly limited, and is, for instance, equal to or lower than 30% by mass, and ranges preferably from 1% by mass to 10% mass.

The thickness of the air electrode layer varies depending on, for instance, the intended use of the air battery, and ranges for instance from 2 μm to 500 μm, preferably from 5 μm to 300 μm.

(Air Electrode Collector)

The air electrode collector used in the embodiment of the invention collects power from the air electrode layer. The material of the air electrode collector is not particularly limited, provided that the material has conductivity. Examples of the material of the air electrode collector include, for instance, stainless steel, nickel, aluminum, iron, titanium and carbon. The air electrode collector may be in the form of, for instance, a foil, a plate, or a mesh (grid). From among the foregoing, the air electrode collector in the embodiment of the invention is preferably in the form of a mesh, since collector efficiency is excellent in this case. In this case, the air electrode collector in the form of a mesh is ordinarily disposed inside the air electrode layer. The lithium battery according to the embodiment of the invention may include a separate air electrode collector (for instance, a collector in the form of a foil), that collects charge that is collected by the air electrode collector in the form of a mesh. In the embodiment of the invention, the below-described battery case may function also as an air electrode collector. The thickness of the air electrode collector ranges for instance from 10 μm to 1000 μm, preferably from 20 μm to 400 μm.

(Negative Electrode)

Preferably, the negative electrode in the lithium battery according to the embodiment of the invention includes a negative electrode active material layer that contains a negative electrode active material. In addition, the negative electrode ordinarily includes a negative electrode collector, and a negative electrode lead connected to the negative electrode collector.

(Negative Electrode Active Material Layer)

The negative electrode layer in the lithium battery according to the embodiment of the invention contains a negative electrode active material that includes a metal and an alloy material. The negative electrode active material used in the negative electrode active material layer is not particularly limited, so long as the material is capable of storing and releasing lithium ions. Examples of the negative electrode active material include, for instance, metallic lithium, a lithium alloy, a metal oxide containing lithium, a metal sulfide containing lithium, a metal nitride containing lithium, and a carbon material such as graphite. The negative electrode active material may be in the form of powder or a thin film. Examples of lithium alloys include, for instance, lithium-aluminum alloys, lithium-tin alloys, lithium-lead alloys, lithium-silicon alloys and the like. Examples of metal oxides containing lithium include, for instance, lithium titanium oxide. Examples of metal nitrides containing lithium include, for instance, lithium cobalt nitride, lithium iron nitride and lithium manganese nitride. Lithium coated with a solid electrolyte can also be used in the negative electrode layer.

The abovementioned negative electrode layer may contain a negative electrode active material alone, or may contain, in addition to the negative electrode active material, at least one of a conductive material and a binder. In a case where, for instance, the negative electrode active material is in the form of a foil, the negative electrode layer may contain the negative electrode active material alone. In a case where the negative electrode active material is in the form of powder, the negative electrode layer may include the negative electrode active material and a binder. Features regarding the conductive material and the binder are identical to those described in the sections “positive electrode active material layer” and “air electrode layer” above, and hence a recurrent explanation thereof will be omitted. The thickness of the negative electrode active material layer is not particularly limited, and ranges for instance from 10 μm to 100 μm, preferably from 10 μm to 50 μm.

(Negative Electrode Collector)

The same materials and forms as described, above for the positive electrode collector can be used for the negative electrode collector.

(Separator)

In a case where the lithium battery according to the embodiment of the invention has a structure resulting from repeated superposition of stacks each including a positive electrode—an electrolyte—a negative electrode, in this order, a respective separator is preferably provided, from the viewpoint of safety, between each positive electrode and each negative electrode belonging to different stacks. Examples of the abovementioned separator include, for instance, a porous film of polyethylene, polypropylene or the like, or a nonwoven fabric such as a resin nonwoven fabric or a glass-fiber nonwoven fabric. The materials that can be used in the separator can be used as supporting materials for the electrolyte solution through impregnation with the above-described electrolyte solution.

(Battery Case)

The lithium battery according to the embodiment of the invention ordinarily includes a battery case that houses the positive electrode, the electrolyte solution, the negative electrode and so forth. Specific examples of the form of the battery case include, for instance, coin forms, flat-plate forms, tubular forms, laminate forms and the like. If the battery according to the embodiment of the invention is a lithium air battery, the battery case may be an open-to-air battery case, or may be a sealed battery case. The open-to-air battery case is a battery case having a structure in which at least the air electrode layer can come into sufficient contact with the atmosphere. If the battery case is a sealed battery case, preferably, a gas (air) introduction tube and venting tube are preferably provided in the sealed battery case. Herein, the gas that is introduced and vented has preferably a high oxygen concentration, and is more preferably pure oxygen. Preferably, the oxygen concentration is raised during discharge, and lowered during charge.

### EXAMPLES

### 1. Synthesis of 1-butyl-3-methyltetrazolium-5-olate

Herein, 1-butyltetrazole-5-thione was synthesized according to reaction formula (a₁) below, as synthesis step (1).

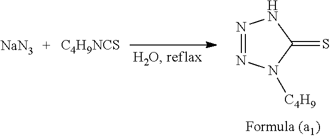

Specifically, 10 mL of water, 487 mg (7.5 mmol) of sodium azide and 0.60 mL (5.0 mmol) of butyl isothiocyanate were added to a recovery flask, and the reaction was left to proceed for 8 hours under reflux. The reaction solution was extracted with ether, the aqueous phase was acidified with concentrated hydrochloric acid, and extraction was performed again with ether, followed by drying with anhydrous sodium sulfate, and solvent evaporation, to yield 707 mg of a pale yellow liquid (1-butyltetrazole-5-thione, yield 90%). ¹HNMR (200 MHz, CDCl₃) δ0.98 (t, J=7.4 Hz, 3H), 133-1.51 (m, 2H), 1.84-2.01 (m, 2H), 4.32 (t, J=7.4 Hz, 2H).

Next, in step (2), 5-butylthio-1-butyltetrazole was synthesized according to reaction formula (b₁) below.

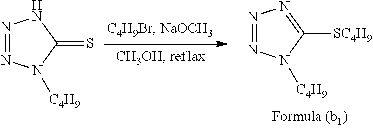

Specifically, 4.97 g (30 mmol) of 1-butyltetrazole-5-thione and 1.44 g (26 mmol) of sodium methoxide were added to a two-mouth recovery flask, and the flask was flushed with argon. There were further added 8 mL of methanol and 2.80 mL (26 mmol) of butyl bromide, with reflux for 16 hours. The solvent was evaporated off, and the product was diluted with ether, was washed with 1N hydrochloric acid, was dried with anhydrous sodium sulfate, and the solvent was evaporated, to yield a pale yellow liquid. The liquid was separated by column chromatography (aminated silica/hexane:ethyl acetate=20:1, acetone), to yield 3.0 g of a pale yellow liquid (5-butylthio-1-butyltetrazole, yield 47%). IR (neat, cm⁻¹) 3584, 3054, 2875, 2305, 1434, 1392, 703. ¹HNMR (200 MHz, CDCl₃) δ0.90 (t, J=7.4 Hz, 3H), 1.26-1.60 (m, 4H), 1.72-1.98 (m, 4H), 3.32 (t, J=7.4 Hz, 2H), 4.20 (t, J=7.4 Hz, 2H). ¹³CNMR (50 MHz, CDCl₃) δ13.2, 13.3, 19.3, 21.5, 30.6, 31.1, 32.7, 46.7, 153.1. EIMS (70 eV) m/z 215 (64), 214 (M⁺, 28), 168 (16), 167 (100), 159 (25), 125 (51), 103 (89).

Third Step

Lastly, 1-butyl-3-methyltetrazolium-5-olate was obtained in step (3) in accordance with reaction formula (c₁) below.

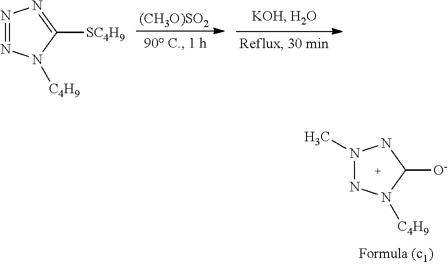

Specifically, 339 mg (1.6 mmol) of 5-butylthio-1-butyltetrazole was added to a two-mouth recovery flask that was then flushed with argon. Further, 165 μL (1.8 mmol) of dimethyl sulfate was added, with heating for 1 hour at 90° C. After cooling, an aqueous solution of potassium hydroxide (126 mg potassium hydroxide, 3 mL water) was added, and heating was performed for 30 minutes under reflux. The product was extracted with methylene chloride and dried with anhydrous sodium sulfate, and the solvent was evaporated off to yield a pale yellow liquid. The liquid was separated by silica gel column chromatography (methylene chloride-acetone), to yield 109 mg of a pale yellow liquid (1-butyl-3-methyltetrazolium-5-olate, yield 44%). The ionic liquid could be distilled at 3 mmHg, 250° C. IR (neat, cm⁻¹) 3584, 3390, 2687, 1565, 1380, 1153, 1078, 895, 736. ¹HNMR (200 MHz, CDCl₃) δ0.92 (t, J=7.4 Hz, 3H), 1.28-1.42 (m, 2H), 1.70-1.92 (m, 2H), 4.02 (t, J=7.4 Hz, 2H), 4.16 (s, 3H). ¹³CNMR (50 MHz, CDCl₃) δ14.0, 22.4, 26.1, 28.5, 31.1, 42.3, 44.5, 161.3. EIMS (70 eV) m/z 157 (100), 156 (M⁺, 74), 114 (81), 101 (63). HRMS (EI) [M⁺]: calcd for C₆H₁₂N₄O 156.1858 found 156.1012.

2: Preparation of an Electrolyte Solution

### Example 1

Herein, lithium bis(trifluoromethanesulfonyl)imide (hereafter also referred to as LiTFSI) was dissolved, to a concentration of 0.32 mol/kg, in 1-butyl-3-methyltetrazolium-5-olate (hereafter also referred to as BMTO) synthesized in accordance with the abovementioned method, to prepare an electrolyte solution of Example 1.

### Example 2

Herein, LiTFSI was dissolved in BMTO synthesized in accordance with the abovementioned method, to a concentration of 1.5 mol/kg, to prepare an electrolyte solution of Example 2.

### Comparative Example 1

Herein, LiTFSI was dissolved in propylene carbonate (hereafter also referred to as PC), as one type of organic solvent, to a concentration of 1 M, to prepare an electrolyte solution of Comparative example 1.

### Comparative Example 2

Herein, LiTFSI was dissolved, to a concentration of 0.32 mol/kg, in N-methyl-N-propyl piperidinium bis(trifluoromethanesulfonyl)imide (hereafter also referred to as PP13TFSI), as one type of ionic liquid, to prepare an electrolyte solution of Comparative example 2.

3. Evaluation of the Lithium Conductivity of the Electrolyte Solutions

The electrolyte solutions of Examples 1 and 2 and Comparative example 1 were subjected to a magnetic field gradient nuclear magnetic resonance (NMR) measurement. The diffusion coefficient D_{Li} of ⁷Li (lithium cation) and the diffusion coefficient D_{F} of ¹⁹F (fluoride anion) were calculated on the basis of the measurement results. The main measurement conditions of magnetic field gradient NMR were as follows. NMR: INOVA300, by Varian; measurement temperature: 60° C.; g: 60(G/cm); δ: 6 (ms)(Li), 4 (ms)(H, F); Δ: 50 (ms). The diffusion coefficients D_{Li} and D_{F} were calculated on the basis of the Stejskal equation (d) below.

$$E = \frac{S}{{S}_{0}} = exp ( - {γ}^{2} {g}^{2} {δ}^{2} D ( Δ - \frac{δ}{3} ) ) \qquad Equation ( d )$$

(In equation (d), E denotes a peak intensity ratio, S denotes peak intensity, S₀ denotes peak intensity measured in a state of no magnetic field gradient; γ denotes the gyromagnetic ratio of nuclear spin, g denotes the magnetic field gradient intensity, δ denotes the irradiation time for the magnetic field gradient, D denotes a diffusion coefficient D_{Li} or D_{F}, Δ denotes the irradiation time interval for the magnetic field gradient.) The lithium ion transport number (t_{Li}) in the electrolyte solution of each of Examples 1 and 2 and Comparative example 1 was determined on the basis of equation (e) below using the values of D_{Li} and D_{F}.

t_{Li}=D_{Li}/(D_{Li}+D_{F}) Equation (e)

The electrolyte solution of Comparative example 2 was subjected to a magnetic field gradient NMR measurement. The diffusion coefficients D_{Li} and D_{F}, as well as the diffusion coefficient D_{H} of ¹H (proton), were calculated on the basis of the measurement results. The lithium ion transport number (t_{Li}) of the electrolyte solution of Comparative example 2 was determined on the basis of equation (f) below, using the values of D_{Li}, D_{F} and D_{H}, as well as the concentration C_{LiTFSI} of LiTFSI, the molecular weight M_{LiTFSI} of LiTFSI and the molecular weight M_{PP13TFSI} of PP13TFSI.

$${t}_{Li} = \frac{{C}_{LiTFSI} \cdot {D}_{Li}}{\begin{matrix}{C}_{LiTFSI} \cdot {D}_{Li} + \\ ( {C}_{LiTFSI} + \frac{1000 - {C}_{LiTFSI} \cdot {M}_{LiTFSI}}{{M}_{PP 13 TFSI}} ) \cdot \\ {D}_{F} + A\end{matrix}} \qquad Equation ( f )$$

In equation (f), A is

$$A = ( \frac{1000 - {C}_{LiTFSI} \cdot {M}_{LiTFSI}}{{M}_{PP 13 TFSI}} ) \cdot {D}_{H}$$

FIG. 2 is a graph illustrating, comparatively the lithium ion transport numbers of the electrolyte solutions of Examples 1 and 2 and Comparative examples 1 and 2. In the graph, the ordinate axis represents the lithium ion transport number, and the abscissa axis represents temperature T (K). FIG. 2 shows that the lithium ion transport number of a conventional electrolyte solution containing an ionic liquid (Comparative example 2) is 0.033 at 313 K (40° C.), 0.035 at 333 K (60° C.) and 0.038 at 353 K (80° C.). The lithium ion transport number of a conventional electrolyte solution containing an organic solvent (Comparative example 1) is 0.39 at 313 K (40° C.), 0.42 at 333 K (60° C.) and 0.47 at 353 K (80° C.). By contrast, the lithium ion transport number of the electrolyte solution of Example 1 is 0.29 at 313 K (40° C.), 0.33 at 333 K (60° C.) and 0.39 at 353 K (80° C.). At all temperatures, the lithium ion transport number is higher, by an order of magnitude, than the lithium ion transport number of Comparative example 2. The lithium ion transport number of the electrolyte solution in Example 2, having 5 times the salt concentration of Example 1, is 0.27 at 333 K (60° C.). The results of Example 1 and Example 2 indicate that there is virtually no drop in the lithium ion transport number through an increase in the lithium salt concentration. The electrolyte solutions of Example 1 and Example 2 exhibit lithium ion conductivity similar to that of the electrolyte solution of Comparative example 1.

1. An electrolyte solution for a lithium battery, comprising: 1-butyl-3-methyltetrazolium-5-olate represented by formula (1).

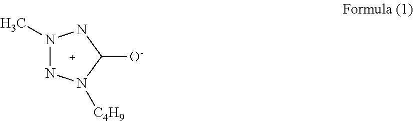

2. A lithium battery, comprising:
a positive electrode;
a negative electrode; and
an electrolyte solution provided between the positive electrode and the negative electrode, wherein
said electrolyte solution is the electrolyte solution for a lithium battery according to claim 1.

3. An electrolyte solution for a lithium air battery, comprising: 1-butyl-3-methyltetrazolium-5-olate represented by formula (1).

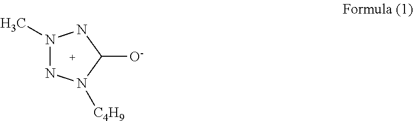

4. A lithium air battery, comprising:
an air electrode;
a negative electrode; and
an electrolyte solution provided between the air electrode and the negative electrode, wherein
said electrolyte solution is the electrolyte solution for a lithium air battery according to claim 3.
